(19) United States
(12) Patent Application Publication
(10) Pub. No.: US 2003/0065861 A1
(43) Pub. Date: Apr. 3, 2003

(54) Dual system masters

(76) Inventors: Clyde S. Clark, Atascadero, CA (US); David W. Radecki, Paso Robles, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/967,036

(22) Filed: Sep. 28, 2001

(51) Int. Cl. G06F 13/14

(52) U.S. Cl. 710/305

(57) ABSTRACT

A method and apparatus are described for operating a first processor connected with a first bus in an active mode so that the first processor controls the first bus, operating a second processor connected with a second bus in an active mode so that the second processor controls the second bus, detecting faults via hardware associated with the first processor and the second processor, and responsive to an occurrence of a fault in the first processor, transferring control of the first bus to the second processor via hardware associated with the first processor and the second processor.

### FIELD OF THE INVENTION

The invention relates generally to the field of high availability computer systems. More particularly, the invention relates to dual active system masters in a split bus system.

### BACKGROUND OF THE INVENTION

Various applications of computer hardware require high levels of availability and reliability of that hardware. That is, the user of such hardware expects the hardware to be available for use in his application a high percentage of the time. For example, a telecommunications provider requires hardware that provides high level of availability of service for his applications.

To address these requirements, hardware providers have developed redundant systems. These systems provide higher levels of availability than non-redundant systems by providing backup hardware available for use in the event of a failure. Two well-known redundancy models are the 2N model and the N+1 model.

FIG. 1 is a block diagram illustrating a system implementing a 2N redundancy model. In this example, two systems 105 and 110 are used. These two systems 105 and 110 are exact duplicates connected to each other via a communication channel 115 used for synchronizing the two systems. In this example, each system 105 and 110 include storage 125, a power supply 120, fans 130, CPUs 140, and peripherals 135. The two systems 105 and 110 function as two separate, independent systems. However, if one becomes unavailable, the other assumes all functions of unavailable system.

FIG. 2 is a block diagram illustrating a system implementing an N+1 redundancy model. This system 205 consists of disks 215, power supplies 210, fans 220, peripherals 225, and CPUs 230. In this example, one more of each element of the system than needed is supplied. For example, four power supplies 210 are provided but only three are needed to operate the system. Therefore, one extra power supply is provided to act as a backup in the event of a failure of another. Redundant components can also be provided for the disks system 215, fans 220, peripherals 225 and CPUs 230.

The 2N and N+1 redundancy models provide protection from failures and improve availability. However, problems remain with these models as they are typically implemented. The 2N model can be inefficient. That is, since completely redundant systems are used, utilization of resources may not be efficient. Models with a redundant CPUs present difficulties in environments where they share a bus such as the N+1 model since only one device at a time may control the bus. Additionally, a switch-over following a CPU failure generally requires a power-down or reset of the remaining CPU before it can take over for the failed CPU. This interrupts service.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram illustrating a system implementing a 2N redundancy model;

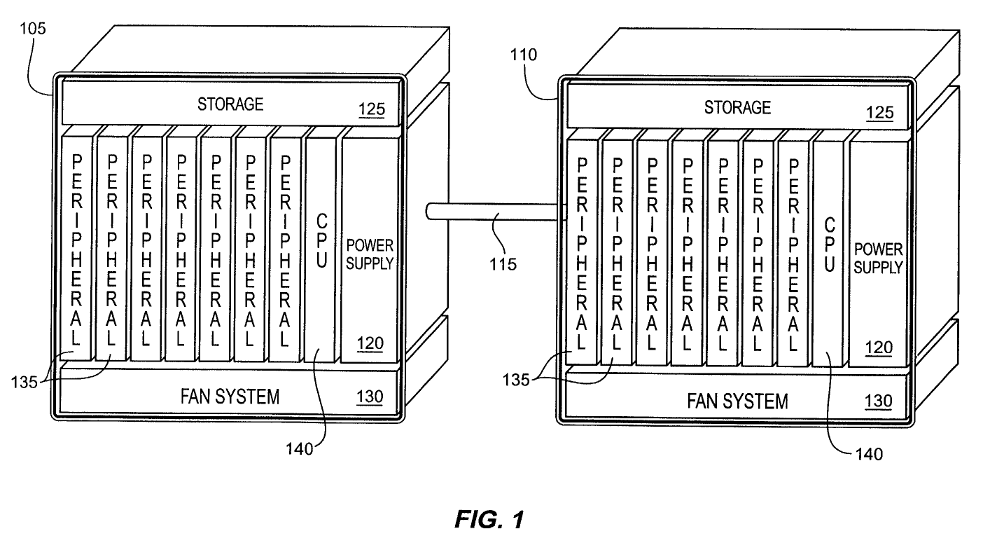

FIG. 2 is a block diagram illustrating a system implementing an N+1 redundancy model;

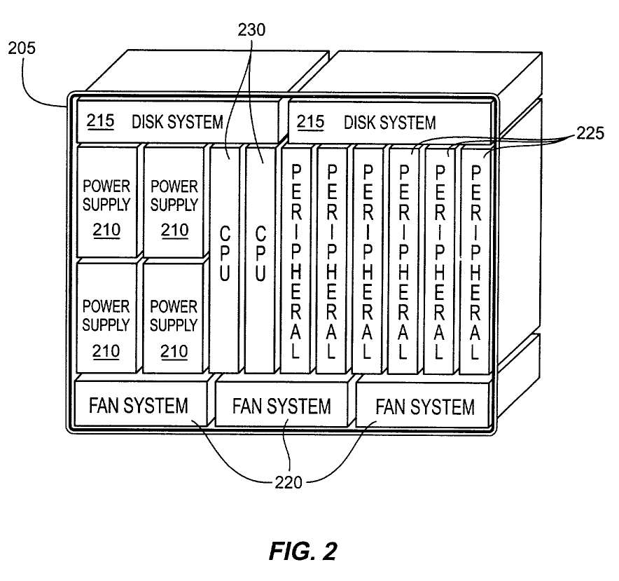

FIG. 3 is a block diagram illustrating Redundant System Slot system logical connections;

FIG. 4 is a block diagram illustrating Redundant System Slot system logical connections when operating in an active/standby mode;

FIG. 5 is a block diagram illustrating Redundant System Slot system logical connections when operating in an active/active mode;

FIG. 6 is a block diagram illustrating Redundant System Slot system logical connections when operating in a cluster-in-a-box mode;

FIG. 7 is a block diagram illustrating a Redundant System Slot architecture upon which embodiments of the present invention may be implemented;

FIG. 8 is a block diagram illustrating a Redundant Host Controller architecture upon which embodiments of the present invention may be implemented;

FIG. 9 is a block diagram illustrating a hierarchical view of a Redundant System Slot (RSS) architecture upon which embodiments of the present invention may be implemented;

FIG. 10 is a flowchart illustrating a high level view of a system boot process according to one embodiment of the present invention;

FIG. 11 is a flowchart illustrating a backup mode boot process according to one embodiment of the present invention;

FIG. 12 is a flowchart illustrating an active mode boot process according to one embodiment of the present invention; and

FIG. 13 is a flowchart illustrating a system master switch-over process according to one embodiment of the present invention.

### DETAILED DESCRIPTION OF THE INVENTION

A method and apparatus are described for operating a first processor connected with a first bus in an active mode so that the first processor controls the first bus, operating a second processor connected with a second bus in an active mode so that the second processor controls the second bus, detecting faults via hardware associated with the first processor and the second processor, and responsive to an occurrence of a fault in the first processor, transferring control of the first bus to the second processor via hardware associated with the first processor and the second processor.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to the Redundant System Slot specification and CompactPCI as described in the .CompactPCI Redundant System Slot Specification PICMG 2.13 Draft 0.51 May 3, 2001 cited in an IDS, the method and apparatus described herein are equally applicable to other redundant systems and bus standards.

Terminology

Before describing an illustrative environment in which various embodiments of the present invention may be implemented, brief definitions of terms used throughout this application are given below.

Active/Active—A system mode of operation that has two system masters operating in split mode on alternate bus segments.

Active host—A system master that is in active mode on both bus segments.

Active mode—The mode of operation of a bus segment interface perspective of a system master when the bridge is not isolated from the backplane, clocks are enabled, arbitration is enabled, and software has the ability to configure devices on the bus segment.

Active/standby—A system mode of operation that has one system master acting as the active host and one acting as a backup host.

Backup host—A system master that is not in active mode on any bus segment.

Cluster mode—A system mode of operation that has two system masters locked into split mode on alternate bus segments. A system in cluster mode does not do fail-over of bus segments.

Redundant host—From the perspective of the system master, the redundant host is the other system master that may be in the system regardless of the operating mode of either system master.

Split mode host—a system master that is in active mode on only one bus segment.

System master—A board within a CompactPCI system that provides arbitration, clock distribution, reset, interrupt, and enumeration functions to peripheral slots. In a non-redundant configuration, the system master represents a single point of failure. In a redundant configuration the signals necessary to provide system master functions are also connected to a redundant system master that becomes active in the event of a failure.

System slot—A location on a CompactPCI backplane in which a system master may be placed.

The Redundant System Slot (RSS) standard, as will be summarized below, is described in the CompactPCI Redundant System Slot Specification PICMG 2.13 Draft 0.51 May 3, 2001 cited in an IDS. Briefly, this standard describes a redundant system with characteristics similar to the N+1 redundancy model described above. Generally, the system includes a system slot board that is much like a motherboard in PC. This system slot board provides control functions like clock, bus arbitration etc. However, prior implementations of RSS systems allow only one system slot board at a time to provide these functions to a particular bus segment. Further details of the RSS system are described below.

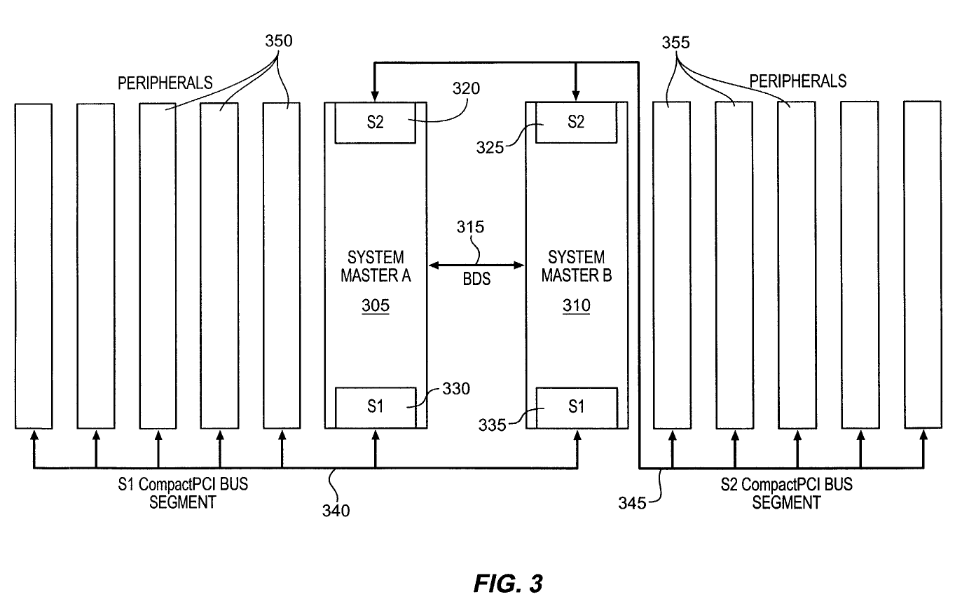

FIG. 3 is a block diagram illustrating Redundant System Slot (RSS) system logical connections. This system includes two system slot boards or system masters 305 and 310. These system masters 305 and 310 are connected to one another via a communication link 315. Typically, this communication link 315 is an Ethernet connection. However, other communication standards may be used. The purpose of the communication link 315 is to allow the system masters 305 and 310 to maintain synchronization.

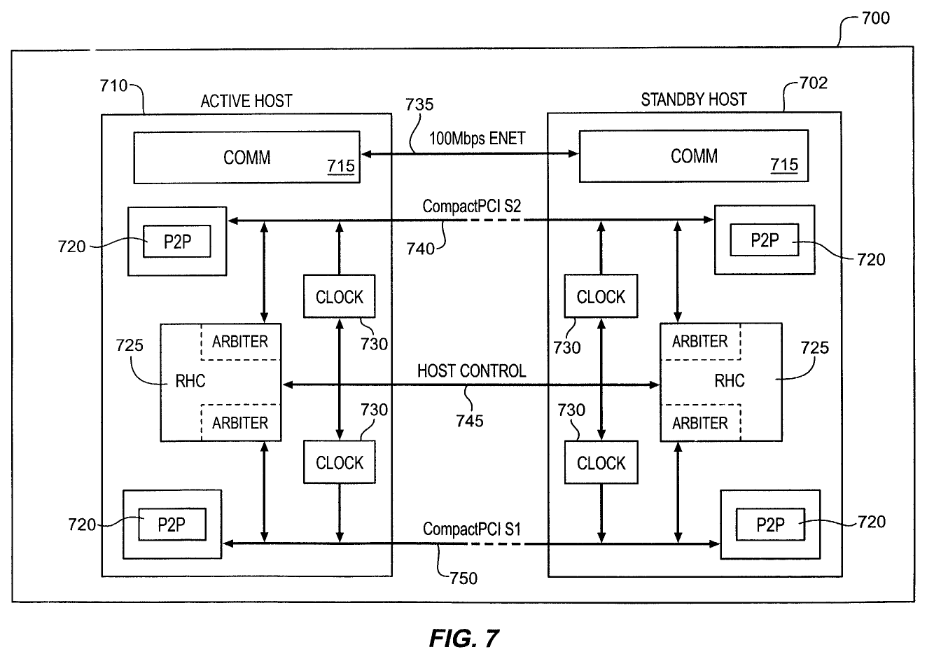

Each system master 305 and 310 is connected with two bus segments 340 and 345. These bus segments 340 and 345 are typically CompactPCI busses but may be another bus architecture. The system masters 305 and 310 are each connected with the bus segments 340 and 345 via PCI-to-PCI bridges 320-335. The details of these bridges will be discussed below with reference to FIG. 7. Each bus segment 340 and 345 is also connected with a number of peripherals 350 and 355. These peripherals can be of any type compatible with the bus architecture used by the two bus segments 340 and 345.

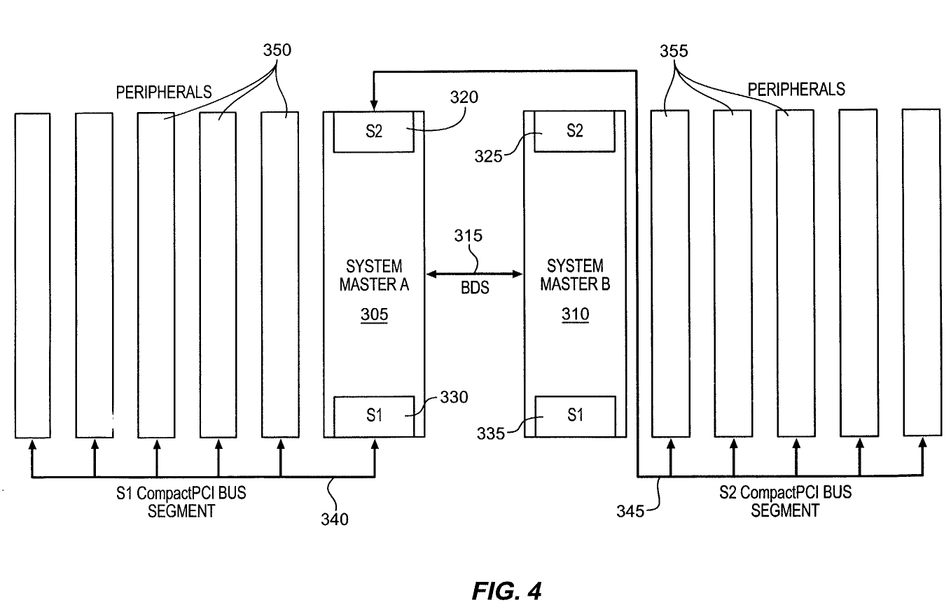

The two system masters 305 and 310 can operate in a variety of modes. These modes include active/standby, active/active, and cluster-in-a-box. Details of each of these modes will be discussed below with reference to FIGS. 4-6.

FIG. 4 is a block diagram illustrating Redundant System Slot (RSS) system logical connections when operating in an active/standby model. The active/standby model illustrated here has one active system master, in this case system master A 305, controlling all the peripherals 350 and 355 on the two bus segments 340 and 345 at any one time. The standby system master, in this case system master B 310, is idle waiting for a fail-over to occur. That is, if system master A 305 fails, system master B 310 assumes control of all peripherals 350 and 355 on both busses 340 and 345. This model provides a high level of availability. However, it does not make full use of system resources since only one system master is able to contribute resources at a any one time. Additionally, the active/standby model requires customers to specifically architect their software to take advantage of this model.

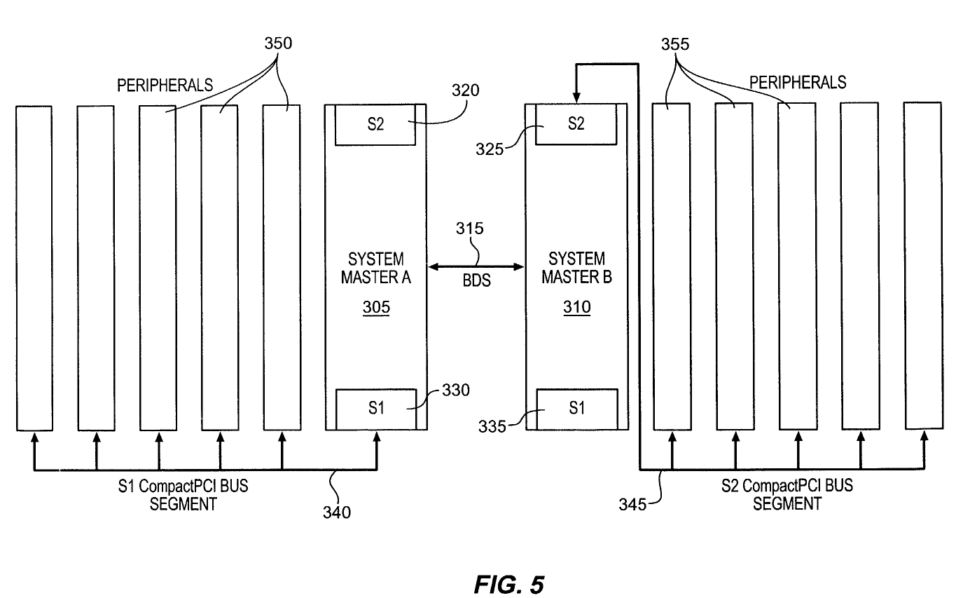

FIG. 5 is a block diagram illustrating Redundant System Slot (RSS) system logical connections when operating in an active/active mode according to one embodiment of the present invention. The active/active model has each system master controlling one bus segment at a time. In this case, system master A 305 controls bus segment S1 340 and its attached peripherals 350. Likewise, system master B 310 controls bus segment S2 345 and its attached peripherals 355. Each system master also acts as a standby for the other segment. For example, if system master A 305 were to fail, system master B 310 would then assume control of bus segment S1 340 and its attached peripherals 350. In this model, both system masters are able to contribute resources. Like the active/standby model, customers must specifically architect their software to take advantage of the benefits of this model. This model allows the boards to quickly fail-over into an active/standby state.

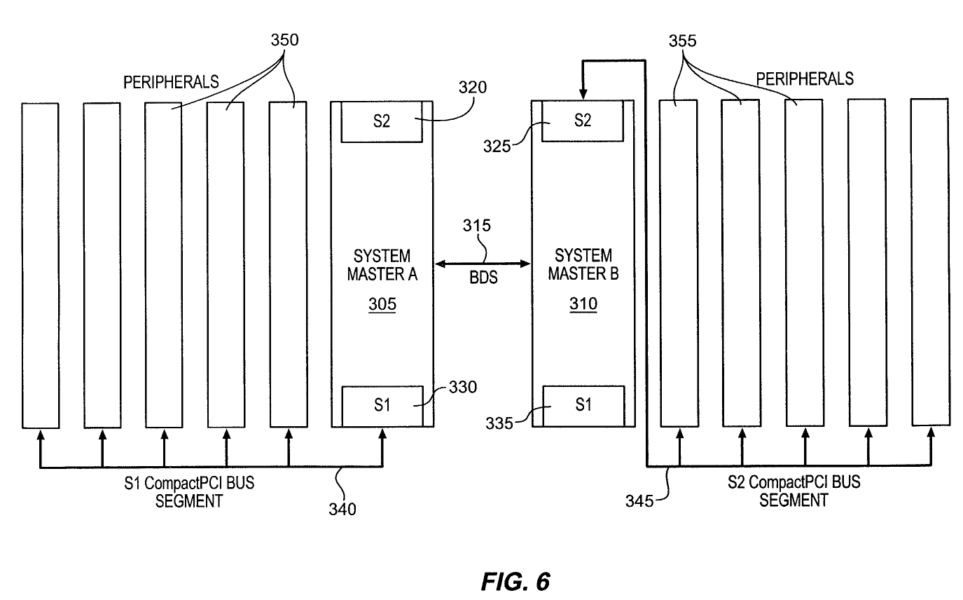

FIG. 6 is a block diagram illustrating Redundant System Slot (RSS) system logical connections when operating in a cluster-in-a-box mode according to one embodiment of the present invention. This model is a variant of the active/active model. That is, it acts like the active/active model but it is locked so that no fail-over occurs. In this case, system master A 305 controls bus segment S1 340 and its attached peripherals 350. Likewise, system master B 310 controls bus segment S2 345 and its attached peripherals 355. However, unlike the active/active model, if system master A 305 were to fail, system master B 310 would not assume control of bus segment S1 340 and its attached peripherals 350. Faults can be detected and reported to software but there is no change of control of bus segments.

In this model, both system masters are able to contribute resources. This model provides for efficient use of resources without the need of specially designed device drivers and accompanying system management software. Previously, this model had been accomplished using a split backplane or specialized software.

According to one embodiment of the present invention, the redundancy model can be changed without shutting down or resetting the chassis or the boards that reside within the chassis. In normal operation, a system is configured to run within a specific model and only transition to another model when circumstances dictate. Such circumstances include, but are not limited to, the failure of an active host system master, or the replacement of a driver with one that has different characteristics than the one being replaced.

According to another embodiment of the present invention, fault detection and action initiation is accomplished through hardware. Existing products perform fault detection and action initiation through software interfaces. In such a system, software on both system masters communicate back and forth during normal operation. If one side does not respond within a time out period, then a fault or error is assumed and the remaining system master must be reset to allow it to change modes.

FIG. 7 is a block diagram illustrating a Redundant System Slot (RSS) architecture upon which embodiments of the present invention may be implemented. In this system 700, two system master boards are shown 701 and 702. In this example, one system master 701 is acting as an active host while the other system master 702 is acting as a standby host. The two system masters 701 and 702 are connected with each other via an Ethernet link 735, two busses 740 and 750, and a host control line 745. The Ethernet link 735 is used primarily for maintaining synchronization between the two system masters 701 and 702 during normal operations so that the standby host 702 is ready to takeover control of devices attached to the active host 701 in event of a failure. Of course, this link 735 may be of another type, such as a simple serial or parallel link. The two busses 740 and 750 are used to provide both system masters 701 and 702 with access to peripheral devices connected with these busses 740 and 750. In this example, a CompactPCI bus is indicated but other bus standards may be used as well. The host control line 745 is provided to allow for coordinated control of the two busses 740 and 750 between the two system masters 710 and 702. For example, this line 745 will be used to pass control signals used during startup and at the time of fail-over, such as requesting and sending maps of bus devices, indicating a system master's mode of operation, and sending failure notifications.

Each system master 701 and 702 contains a communications module 715, PCI-to-PCI bridges 720, clocks 730, and a Redundant Host Controller (RHC). The communication modules 715, connected with the Ethernet link 735, are used primarily for maintaining synchronization between the two system masters 701 and 702 during normal operations so that the standby host 702 is ready to takeover control of devices attached to the active host 701 in event of a failure. The PCI-to-PCI bridges 720, together with the two busses 740 and 750, are used to provide the system masters 701 and 702 with access to peripheral devices connected with these busses 740 and 750. In this example, a CompactPCI bus is indicated but other bus standards may be used as well. The functions of the clocks 730 are to provide required clock signals to the two busses 740 and 750. Finally, the Redundant Host Controller (RHC), together with the host control line 745, is used to provide bus arbitration on the two busses 740 and 750 and allow for coordinated control of the two busses 740 and 750 between the two system masters 701 and 702. For example, the RHC will generate, receive, and respond to control signals used during startup and at the time of fail-over such as requesting and sending maps of bus devices, indicating a system master's mode of operation, and sending failure notifications.

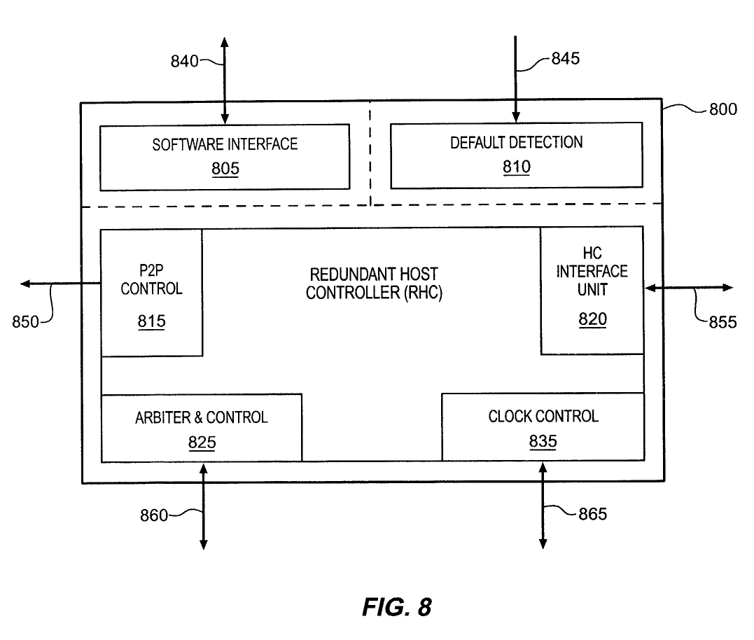

FIG. 8 is a block diagram illustrating a Redundant Host Controller architecture upon which embodiments of the present invention may be implemented. In this example, a Redundant Host Controller 800 is illustrated. This RHC 800 includes a software interface 805 and fault detection module 810. The software interface 805 provides access 840 to the RHC 800 to any application programs running one the system master. The fault detection module 810 receives notification 845 of faults from fault detection hardware (not shown) and initiates an appropriate response.

Also included in the RHC 800 are a P2P bridge control module 815, a bus arbiter and control module 825, a power and reset control module 830, a clock control module 835 and a host controller interface unit 820. The P2P (PCI-to-PCI) bridge control module 715, together with the two busses 740 and 750 discussed above, are used to provide system masters with access 850 to peripheral devices connected with these busses 740 and 750. The bus arbiter and control module 825 is used to provide 860 bus arbitration on the two busses 740 and 750 and allow for coordinated control of the two busses 740 and 750 between system masters. The clock control module provides required clock signals 865 to the two busses 740 and 750. Finally, the HC interface unit 820 will generate, receive, and respond to control signals 855 used during startup and at the time of fail-over such as requesting and sending maps of bus devices, indicating a system master's mode of operation, and sending failure notifications.

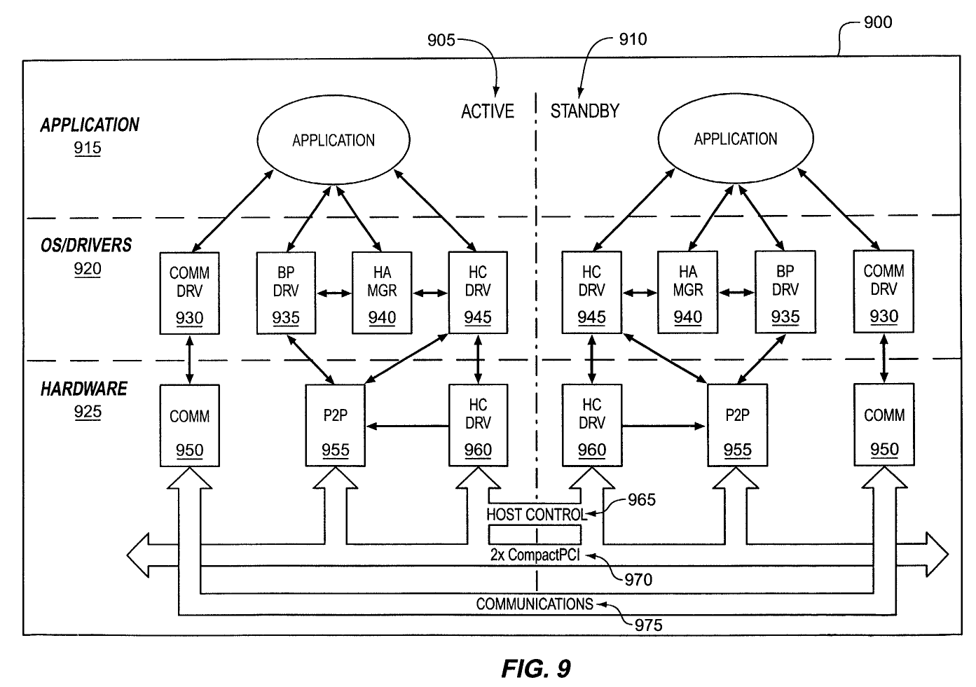

FIG. 9 is a block diagram illustrating a hierarchical view of a Redundant System Slot (RSS) architecture upon which embodiments of the present invention may be implemented. In this system 900, two system master boards are shown 905 and 910. In this example, one system master 905 is acting as an active host while the other system master 910 is acting as a standby host. The hierarchy is divided into an application level 915, an OS/driver level 920, and a hardware level 925. The application level 915 consists of an individual users application programs and are therefore beyond the scope of this description.

The hardware level 925 consists of the communication module 950, PCI-to-PCI bridge 955, and host controller 960. The functions of these components have been described above with reference to FIG. 7. Also in the hardware level are the host control link 965, busses 970 and communication link 975 or Ethernet link. Once again, the functions of these components have been described above with reference to FIG. 7.

The OS/driver level 920 consists of communications drivers 930, bridge and peripheral drivers 935, high availability managers 940, and host controller drivers 945. The communications drivers simply provide driver control for the communications modules 950. Similarly, the bridge and peripheral drivers 935 provide driver control for the PCI-to-PCI bridges 955. In addition, the bridge and peripheral drivers provide driver control for peripheral devices connected with the busses 970. The host controller drivers 945 provide drivers for the host controller hardware 960 and monitor the PCI-to-PCI bridges 955 to enable the host controllers 960 to provide bus arbitration on the two busses 970 and allow for coordinated control of the two busses 970 between the two system masters 905 and 910. For example, the RHC will generate, receive, and respond to control signals used during startup and at the time of fail-over, such as requesting and sending maps of bus devices, indicating a system master's mode of operation, and sending failure notifications.

The high available manager 940 provides an interface between the bridge and peripheral drivers 935 and the host controller drivers 945. Generally, the high availability manager monitors installed drivers for peripherals connected with the busses 970 to determine whether they are compatible with the host controller driver. In one embodiment of the present invention, this compatibility may be based on the well-know High Availability (HA) requirements for CompactPCI devices as described in the CompactPCI Redundant System Slot Specification PICMG 2.13 Draft 0.51 May 3, 2001 cited in an IDS.

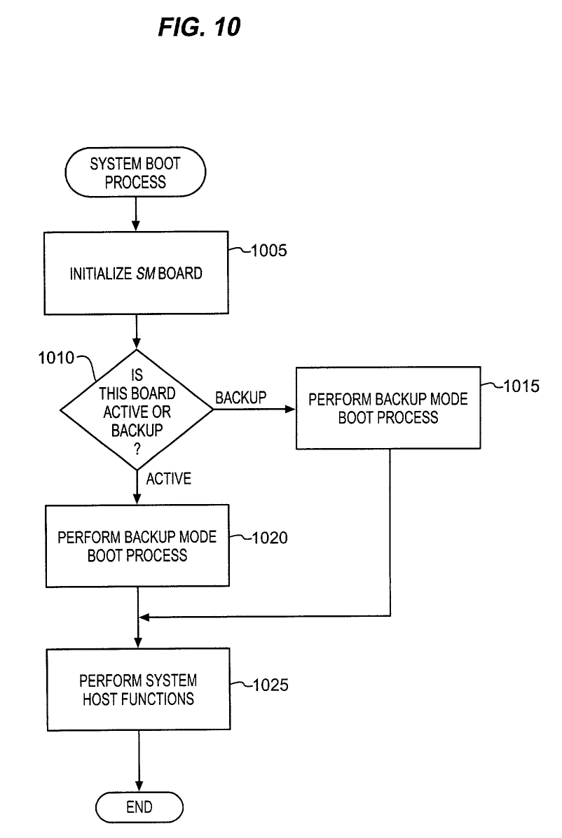

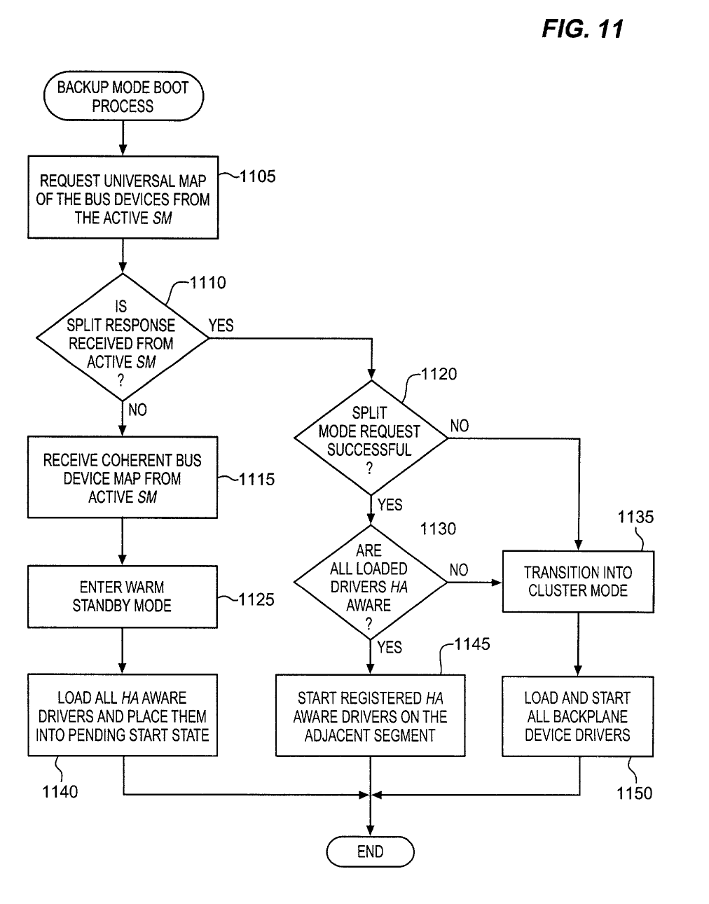

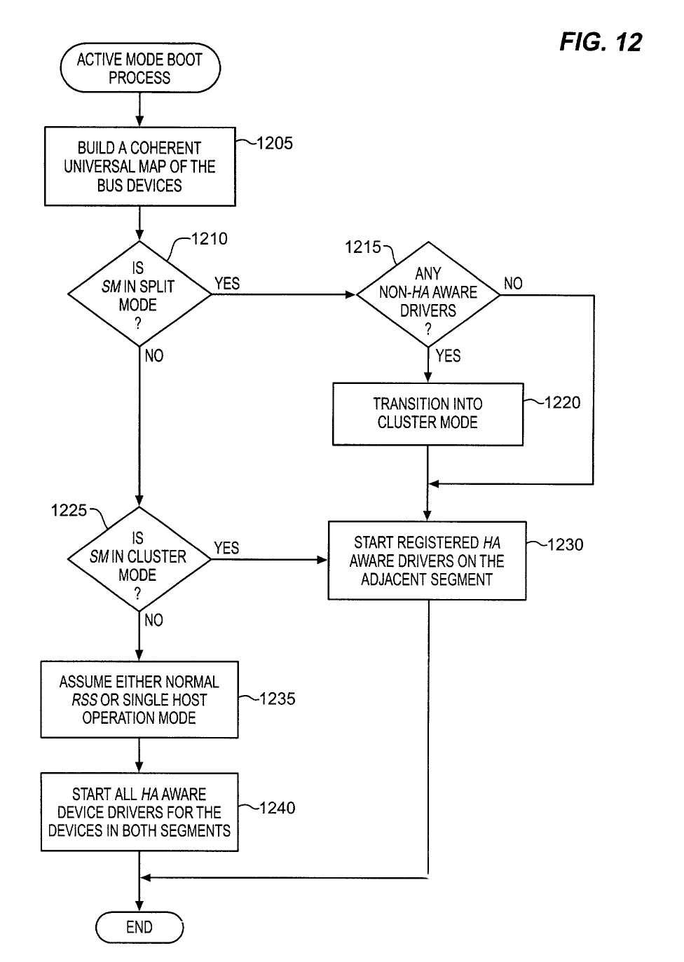

FIG. 10 is a flowchart illustrating a high level view of a system boot process according to one embodiment of the present invention. First, at processing block 1005, when the system master (SM) board is first energized it is initialized. That is, the processor begins running and executes the system BIOS and other start-up programs if any. Next, at decision block 1010, a determination is made as to whether this board is pre-configured to operate in an active or backup mode. This determination can be based on pre-configured information in the processor's BIOS. If the board is configured to operate in backup mode, a backup mode boot process is performed at processing block 1015. Details of this process will be described below with reference to FIG. 11. If the board is configured to operate in an active mode, an active mode boot process is performed at processing block 1020. Details of this process will be described below with reference to FIG. 12. Finally at processing block 1025, the SM board begins performing normal system host functions.

FIG. 11 is a flowchart illustrating a backup mode boot process according to one embodiment of the present invention. Initially, at processing block 1105, the SM board requests a universal map of the bus devices from the active SM board. At decision block 1110, a determination is made whether the active SM board response indicates a split mode. This determination can be based on preconfigured information in the processor's BIOS. If a split mode is not indicated, the SM board receives a coherent bus device map from the active SM at processing block 1115, enters a warm standby mode at processing block 1125, and loads all High Availability (HA) Aware compatible device drivers and places them into a pending start state at processing block 1140.

If, at decision block 1110, a split mode is indicated, a determination is made at decision block 1120 whether the split mode request from the active SM was successful. If the request was not successful, the SM board transitions into a cluster mode at processing block 1135 and loads and starts all backplane device drivers at processing block 1150. If the split mode request was successful at decision block 1120, a determination is made at decision block 1130 as to whether all loaded drivers are HA Aware compatible. If all drivers are compatible, the SM board starts all registered drivers on the adjacent bus segment at processing block 1145. If not all drivers are compatible, the SM board transitions into a cluster mode at processing block 1135 and loads and starts all backplane device drivers at processing block 1150.

FIG. 12 is a flowchart illustrating an active mode boot process according to one embodiment of the present invention. First, the SM board builds a coherent universal map of all bus devices at processing block 1205. At decision block 1210, a determination is made as to whether the SM board is designated to operate in split mode. If the SM board is not to operate in split mode, a determination is made at decision block 1225 as to whether the SM board is to operate in cluster mode. If the SM is to operate in cluster mode, the SM board starts all registered HA Aware compatible device drivers on the adjacent bus segment. If the SM board is to not operate in cluster mode at decision block 1225, the board assumes either normal RSS or single host operation mode at processing block 1235 and starts all HA Aware device drivers for the devices in both segments at processing block 1240.

If, at decision block 1210, the SM board is to operate in split mode, a determination is made at decision block 1215 as to whether there are any device drivers that are not HA Aware compatible. If all drivers are compatible, the SM board starts all registered drivers on the adjacent bus segment at processing block 1230. If there are drivers that are not compatible at decision block 1215, the SM board transitions into a cluster mode at processing block 1220 and then starts all registered drivers on the adjacent bus segment at processing block 1230.

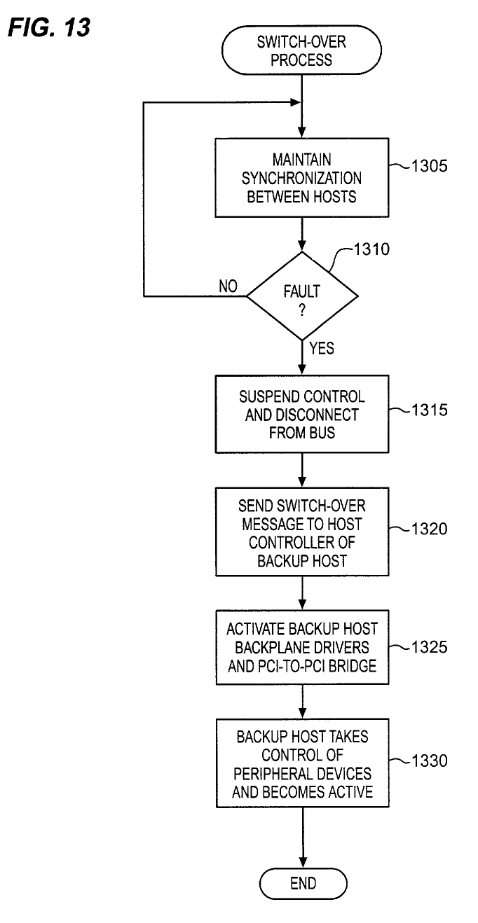

FIG. 13 is a flowchart illustrating system master switch-over process according to one embodiment of the present invention. Initially, at processing block 1305, the SM boards maintain synchronization during normal operation. Once a fault is detected at decision block 1310, the board creating the fault will suspend control and disconnect from the bus at processing block 1315. The board with the fault will then send a switch-over message to the host controller of the backup board at processing block 1320. At processing block 1325 the backup host activates its backplane drivers and PCI-to-PCI bridge. Finally, at processing block 1330, the backup host takes control of the peripheral devices and becomes the active host.

What is claimed is:

1. A method comprising:
operating a first processor connected with a first bus and a second bus wherein the first processor controls the first bus;
operating a second processor connected with the first bus and the second bus wherein the second processor controls the second bus;
detecting faults via hardware associated with said first processor and said second processor; and
responsive to an occurrence of a fault in said first processor, transferring control of said first bus to said second processor via hardware associated with said first processor and said second processor.

2. The method of claim 1, wherein said operating a first processor comprises:
initializing the processor;
determining whether the processor is designated to operate in the active mode or the backup mode;
responsive to the processor being designated to operate in the active mode, performing an active mode boot process;
responsive to the processor being designated to operate in the backup mode, performing a backup mode boot process; and
performing system host functions.

3. The method of claim 2, wherein said determining whether the processor is designated to operate in the active mode or the backup mode is based on preconfigured information in the processor's BIOS.

4. The method of claim 2, wherein said active mode boot process comprises:
building a coherent universal map of devices connected with the first bus and the second bus;
determining whether the active mode is a split mode or a cluster mode;
if the active mode is a split mode, starting drivers on said second bus if all drivers are compatible, and transitioning into a cluster mode if not all drivers are compatible;
if the active mode is a cluster mode, starting all compatible drivers on said second bus; and
if the active mode is neither split mode or cluster mode, assuming a single host operation mode and starting all compatible drivers on the first bus and the second bus.

5. The method of claim 4, wherein said determining whether the active mode is a split mode or a cluster mode is based on preconfigured information in the processor's BIOS.

6. The method of claim 2, wherein said backup mode boot process comprises:
requesting a universal map of devices connected with said first bus and said second bus;
determining whether a split mode response has been received from the second processor;
if a split mode response has not been received,
receiving a coherent map of devices connected said second bus from said second processor,
entering a warm standby mode, and
loading all compatible drivers for devices connected with said first bus and placing them into a pending state; and
if a split mode response has been received,
determining whether a split mode request from the second processor to the first processor has been successful,
if the split mode request has been successful, determining whether all drivers for devices on the first bus are compatible,
starting all registered device drivers on said second bus if all drivers are compatible, and
transitioning into a cluster mode and loading and starting all drivers for said second bus is not all loaded drivers are compatible, and
if the split mode request has not been successful,
transitioning into a cluster mode, and
loading and starting all drivers for devices connected with said first bus.

7. The method of claim 1, wherein said transferring control of said first bus to said second processor comprises:
suspending control of and disconnecting said first processor from said first bus;
sending a switch-over message to said second processor; and
activating device drivers on the second processor to take control of bus devices.

8. The method of claim 1, wherein said bus is a CompactPCI bus.

9. The method of claim 8, wherein said first processor and said second processor comprise Redundant System Slot (RSS) cards.

10. A system comprising:
a first processor connected with a first bus operating in an active mode so that the first processor controls the first bus;
a second processor connected with a second bus operating in an active mode so that the second processor controls the second bus; and
hardware associated with said first processor and said second processor to detect faults in the processors transfer control of said first bus to said second processor via hardware associated with said first processor and said second processor responsive to detection of a fault.

11. The system of claim 10, wherein said first processor:
determines whether the processor is designated to operate in the active mode or the backup mode;
responsive to the processor being designated to operate in the active mode, performs an active mode boot process;
responsive to the processor being designated to operate in the backup mode, performs a backup mode boot process; and
performs system host functions.

12. The system of claim 11, wherein said determining whether the processor is designated to operate in the active mode or the backup mode is based on preconfigured information in the processor's BIOS.

13. The system of claim 11, wherein said active mode boot process comprises:
building a coherent universal map of devices connected with the first bus and the second bus;
determining whether the active mode is a split mode or a cluster mode;
if the active mode is a split mode, starting drivers on said second bus if all drivers are compatible, and transitioning into a cluster mode if not all drivers are compatible;
if the active mode is a cluster mode, starting all compatible drivers on said second bus; and
if the active mode is neither split mode or cluster mode, assuming a single host operation mode and starting all compatible drivers on the first bus and the second bus.

14. The system of claim 13, wherein said determining whether the active mode is a split mode or a cluster mode is based on preconfigured information in the processor's BIOS.

15. The system of claim 11, wherein said backup mode boot process comprises:
requesting a universal map of devices connected with said first bus and said second bus;
determining whether a split mode response has been received from the second processor;
if a split mode response has not been received,
receiving a coherent map of devices connected said second bus from said second processor,
entering a warm standby mode, and
loading all compatible drivers for devices connected with said first bus and placing them into a pending state; and
if a split mode response has been received,
determining whether a split mode request from the second processor to the first processor has been successful,
if the split mode request has been successful, determining whether all drivers for devices on the first bus are compatible,
starting all registered device drivers on said second bus if all drivers are compatible, and
transitioning into a cluster mode and loading and starting all drivers for said second bus is not all loaded drivers are compatible, and
if the split mode request has not been successful,
transitioning into a cluster mode, and
loading and starting all drivers for devices connected with said first bus.

16. The system of claim 10, wherein said transferring control of said first bus to said second processor comprises:
suspending control of and disconnecting said first processor from said first bus;
sending a switch-over message to said second processor; and
activating device drivers on the second processor to take control of bus devices.

17. The system of claim 10, wherein said bus is a CompactPCI bus.

18. The system of claim 17, wherein said first processor and said second processor comprise Redundant System Slot (RSS) cards.

19. A machine-readable medium having stored thereon data representing instructions which, when executed by a processor, cause the processor to:
operate a first processor connected with a first bus and a second bus wherein the first processor controls the first bus;
operate a second processor connected with the first bus and the second bus wherein the second processor controls the second bus;
detect faults via hardware associated with said first processor and said second processor; and
responsive to an occurrence of a fault in said first processor, transferring control of said first bus to said second processor via hardware associated with said first processor and said second processor.

20. The machine-readable medium of claim 19, wherein said operating a first processor comprises:
initializing the processor;
determining whether the processor is designated to operate in the active mode or the backup mode;
responsive to the processor being designated to operate in the active mode, performing an active mode boot process;
responsive to the processor being designated to operate in the backup mode, performing a backup mode boot process; and
performing system host functions.

21. The machine-readable medium of claim 20, wherein said determining whether the processor is designated to operate in the active mode or the backup mode is based on preconfigured information in the processor's BIOS.

22. The machine-readable medium of claim 20, wherein said active mode boot process comprises:
building a coherent universal map of devices connected with the first bus and the second bus;
determining whether the active mode is a split mode or a cluster mode;
if the active mode is a split mode, starting drivers on said second bus if all drivers are compatible, and transitioning into a cluster mode if not all drivers are compatible;
if the active mode is a cluster mode, starting all compatible drivers on said second bus; and
if the active mode is neither split mode or cluster mode, assuming a single host operation mode and starting all compatible drivers on the first bus and the second bus.

23. The machine-readable medium of claim 22, wherein said determining whether the active mode is a split mode or a cluster mode is based on preconfigured information in the processor's BIOS.

24. The machine-readable medium of claim 20, wherein said backup mode boot process comprises:
requesting a universal map of devices connected with said first bus and said second bus;
determining whether a split mode response has been received from the second processor;
if a split mode response has not been received,
receiving a coherent map of devices connected said second bus from said second processor,
entering a warm standby mode, and
loading all compatible drivers for devices connected with said first bus and placing them into a pending state; and
if a split mode response has been received,
determining whether a split mode request from the second processor to the first processor has been successful,
if the split mode request has been successful, determining whether all drivers for devices on the first bus are compatible,
starting all registered device drivers on said second bus if all drivers are compatible, and
transitioning into a cluster mode and loading and starting all drivers for said second bus is not all loaded drivers are compatible, and
if the split mode request has not been successful,
transitioning into a cluster mode, and
loading and starting all drivers for devices connected with said first bus.

25. The machine-readable medium of claim 19, wherein said transferring control of said first bus to said second processor comprises:
suspending control of and disconnecting said first processor from said first bus;
sending a switch-over message to said second processor; and
activating device drivers on the second processor to take control of bus devices.

26. The machine-readable medium of claim 19, wherein said bus is a CompactPCI bus.

27. The machine-readable medium of claim 26, wherein said first processor and said second processor comprise Redundant System Slot (RSS) cards.
